(19) United States
(12) Patent Application Publication
(10) Pub. No.: US 2019/0157670 A1
(43) Pub. Date: May 23, 2019

(54) COMPOSITE CATHODE LAYERED STRUCTURE FOR SOLID STATE BATTERIES ON A LITHIUM BASIS AND A METHOD FOR MANUFACTURING SAME

(71) Applicant: FRAUNHOFER-GESELLSCHAFT ZUR FOERDERUNG DER ANGEWANDTEN FORSCHUNG E.V., Muenchen (DE)

(72) Inventors: Mareike WOLTER, Dresden (DE); Jochen SCHILM, Radebeul (DE); Kristian NIKOLOWSKI, Dresden (DE); Mihails KUSNEZOFF, Dresden (DE)

(73) Assignee: FRAUNHOFER-GESELLSCHAFT ZUR FOERDERUNG DER ANGEWANDTEN FORSCHUNG E.V., Muenchen (DE)

(21) Appl. No.: 16/314,761

(22) PCT Filed: Jun. 30, 2017
(86) PCT No.: PCT/EP2017/066274

§ 371 Date: Jan. 2, 2019

(30) Foreign Application Priority Data
Jul. 1, 2016 (DE) 10 2016 212 050.6

(51) Int. Cl. H01M 4/36; H01M 4/38; H01M 4/04; H01M 4/139; H01M 2/16; H01M 10/0562

(52) U.S. Cl. CPC H01M 4/366; H01M 4/382; H01M 4/0471; H01M 10/0525; H01M 2/1673; H01M 10/0562; H01M 4/139

(57) ABSTRACT

The invention relates to a composite cathode layered structure for solid-state batteries on a lithium basis, in which a barrier layer (3), which is formed from an electronically conductive material, which is not conductive to lithium ions, is formed on a surface of a cathode layer (1) which is formed with an active material which is suitable for temporarily storing lithium ions, a material which is conductive to lithium ions and electrons. On the opposite surface of the cathode layer (1) there is a further layer (2) which forms a barrier layer or a solid electrolyte and is formed from a material which is electronically non-conductive and is conductive to lithium ions, and is connected in a materially joined fashion to the respective surface of the cathode layer (1) as a result of sintering.

The invention relates to a composite cathode layer structure for lithium-based solid-state batteries and a process for the production thereof.

The problem concerns the structure of a solid-state battery. Solid-state batteries consist of an anode, a cathode and usually a solid electrolyte which acts as separator and spatially and functionally separates the two electrodes from one another. To perform their function, the three layers have to be joined to one another by material-to-material bonding or in an ion-conducting manner. Only in this way can reversible charge exchange between the two electrodes in the form of charging and discharging processes occur. Corresponding functions can be performed by ceramic materials as singular components. In the functional composite consisting of cathode, electrolyte and anode and in particular in a bipolar structure, such a composite is not known. A liquid electrolyte is not necessary. In addition, electrically conductive current collectors which should not be conductive for cations are applied to the respective free surfaces of the two electrodes.

General advantages of a lithium-based solid-state battery are a high energy density, due to the use of metallic lithium as anode material, and increased safety because combustible organic components, which according to the prior art are used as electrolyte and as binder, can be dispensed with. A consequence of this ion-conducting or material-to-material bonding of the individual constituents is that considerable mechanical stresses can be present in the structure. They result from volume changes experienced by the participating materials during charging and discharging processes.

In structures according to the prior art, plastically reversibly deformable ion-conducting polymers (e.g. PEO modified with the lithium salt TFSi) are used instead of hard and brittle, ceramic solid electrolytes. A significant disadvantage of polymeric solid electrolytes is their limited stability in respect of the growth of lithium dendrites (risk of short circuits), their combustibility in the case of damage to the battery and also their low electrochemical stability in the case of particular combinations of electrode materials. These disadvantages at least partly negate the abovementioned advantages of a solid electrolyte battery.

The replacement of the polymeric electrolyte by an inorganic material which is conductive for lithium ions and can be integrated into a composite cathode structure, e.g. a vitreous or ceramic solid electrolyte, would be a solution to this problem since these materials have a higher stability to electric potentials at elevated temperatures. A resulting completely inorganic composite cathode structure should be able to satisfy mechanical (temperature change and differences in coefficients of thermal expansion) and electrochemical aspects (charging and discharging processes) or be able to prevent their occurrence from the beginning by suitable choice of materials and design.

It is therefore an object of the invention to provide lithium-based solid-state batteries in which the anodes are composed of metallic lithium or comprise lithium and which are simple and reliable to produce and achieve a long life and also increased safety.

This object is achieved according to the invention by a composite cathode layer structure which has the features of claim 1. A production process for such a structure is defined in claim 8. Advantageous embodiments and further developments can be realized by means of features specified in dependent claims.

The present invention relates to a low-mechanical stress composite cathode layer structure for use in a bipolar construction in a cathode-supported solid-state battery and a process for the production thereof. As regards the structure of the solid-state battery, a composite cathode layer structure can take on the function of the supporting element of a repeating unit. The composite cathode layer structure consists of a multiphase sintered substrate as cathode layer which is provided on one side with an ion-conducting, electrically insulating further layer and on the other side with an electrically conducting but not ion-conducting further barrier layer. The further layer can be a barrier layer on which a layer forming a solid electrolyte can be formed or directly, without additional layer, on its own forms the solid electrolyte.

An anode material composed of metallic lithium or containing lithium can be arranged as anode directly on the further layer or on a solid electrolyte layer formed on a further layer to form a solid electrolyte. A plurality of such composite cathode layer structures between which an anode is arranged in each case can, when suitably electrically connected, form a solid-state battery having an increased electric voltage or storage capacity.

The two layers present on the surfaces of the cathode layer alternately form an electrically conductive bond and an ionically conductive bond to respectively adjacent anodes, where one of the two anodes together with the coated composite cathode forms a fully functional cell and the other anode represents part of an adjacent cell.

The cathode layer can comprise an active material suitable for the temporary storage of lithium ions, a material which conducts lithium ions and electrons, the barrier layer can comprise a metal or a carbon-containing glass or ceramic material and/or the further layer can comprise a lithium ion-conductive glass or ceramic material or combinations thereof.

The composite cathode layer structure consists of three significant components. Firstly, an isotropic ion conductivity over all dimensions of the cathode is ensured by a sintered, glass-based electrolyte material as lithium ion-conducting material which in the cathode forms a percolating structure. This glass-based electrolyte material additionally ensures the structural integrity of the cathode. Examples of potentially suitable low-melting and ion-conducting glasses may be found in the relevance specialist literature. For this purpose, FIG. 2 shows two graphs of the temperature-dependent conductivity of various Li₂O-based glasses (from: Solid State batteries: Materials Design and optimization, ISBN 0-7923-9460-7, 1994), Kluwer Academic press).

Furthermore, an isotropic electronic conductivity over all dimensions of the cathode structure is ensured by a further percolating electronically conductive barrier layer which is integrated into the sintered glass structure.

In order to make storage of electric charge possible, an appropriate cathodic active material, for example LiNiₓMn_{y}Co_{z}O₂ where x+y+z=1 (NMC), LiNi_{0.8}Co_{0.15}Al_{0.05}O₂ (NCA), glass-based cathode materials, high-voltage spinels (LiNiₓMn₂₋ₓO₄ where 0<x<0.5), phosphates (LiMPO₄ where M=Fe, Co, Ni, Mn) is present as third component in the cathode layer structure, in particular in the cathode layer.

The composite cathode layer structure thus has a ternary structure which has electric conductivity, ionic conductivity and storage capability for electrons and lithium ions.

The ion-conductive further layer is joined at one surface in an ion-conducting manner to the cathode layer. It can serve to provide a possibly required later connection to an ion-conducting solid electrolyte and should have a smooth, defect-free surface. It ideally consists of a glass which is chemically identical or similar to the glass used for the cathode layer.

The electronically conductive barrier layer is electrically conductively joined on the surface arranged opposite the cathode layer to the latter. It can consist of a metal layer (e.g. aluminum, copper or nickel). A prerequisite here is nonmiscibility of the metal used with lithium in order to avoid alloy formation at the joint and to ensure resistance to the cathode layer material selected. However, it can also consist of a sintered electronically conductive binary glass-carbon composite which is bound electrically conductively by a material-to-material bond to the cathode layer or is sintered to the latter. Its function is to spatially separate the composite cathode layer structure from the adjacent anode corresponding to the bipolar structure of a solid-state battery. However, electrical contact between composite cathode layer structure and neighboring anode has to be ensured here in order to make electric charge transport possible. The coefficient of thermal expansion of the binary glass-carbon composite of the barrier layer should largely correspond to that of the cathode layer in order to avoid mechanical stresses in the composite. Metallic coatings which perform the same function should be made so thin that the mechanical stresses arising at the bond do not cause damage to the composite cathode layer structure. Furthermore, the softening temperature of the glass phase of a power outlet path should correspond to that of the vitreous or ceramic solid electrode materials used for the cathode layer so as to avoid excessive softening or structural changes of the composite cathode layer structure when the glass phase is sintered or cosintered onto the latter.

The invention makes it possible to realize a composite cathode layer structure which is free of organic (noncombustible and toxic) components since inorganic nonmetallic glasses can be used as auxiliary electrolytes and binder phases.

The use of a low-melting, ion-conducting glass makes it possible to realize a multilayer cathode layer having minimized thermomechanical stresses.

An electrically conductive glass-carbon barrier layer which is sintered by a material-to-material bond to one side of the cathode layer makes it possible to achieve electrically conductive contact to an adjacent anode.

An ionically conductive further layer which is sintered by a material-to-material bond to the respective other side of the cathode layer can establish an ionically conductive contact to a further additional solid electrolyte layer which in turn realizes contact to the next anode of an adjacent cell.

The production of the three functional layers can be achieved simultaneously in a cosintering process.

It is possible to join the ionically conductive further layer in an ionically conductive manner to a ceramic solid electrolyte by means of a further process step.

The invention will be illustrated by way of example below. Here, the features utilized in the individual examples can be combined with one another independently of the respective individual example.

### THE FIGURES SHOW

FIG. 1 an example in schematic form of a composite cathode layer structure according to the invention and

FIG. 2 two graphs of the temperature-dependent conductivity of various Li₂O-containing glasses.

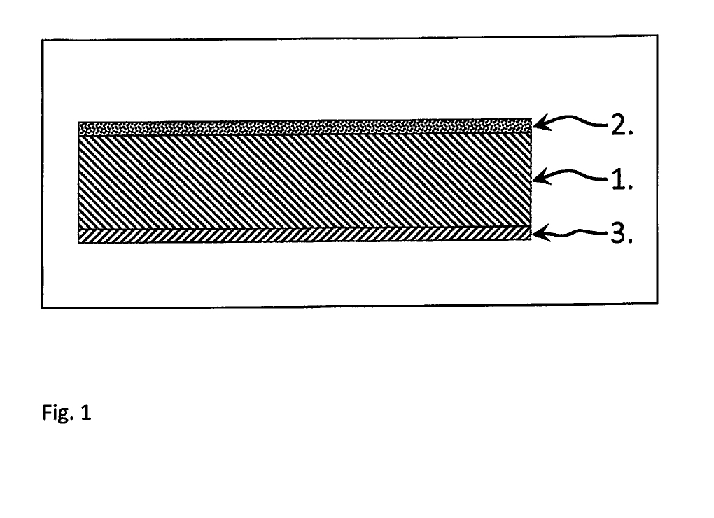

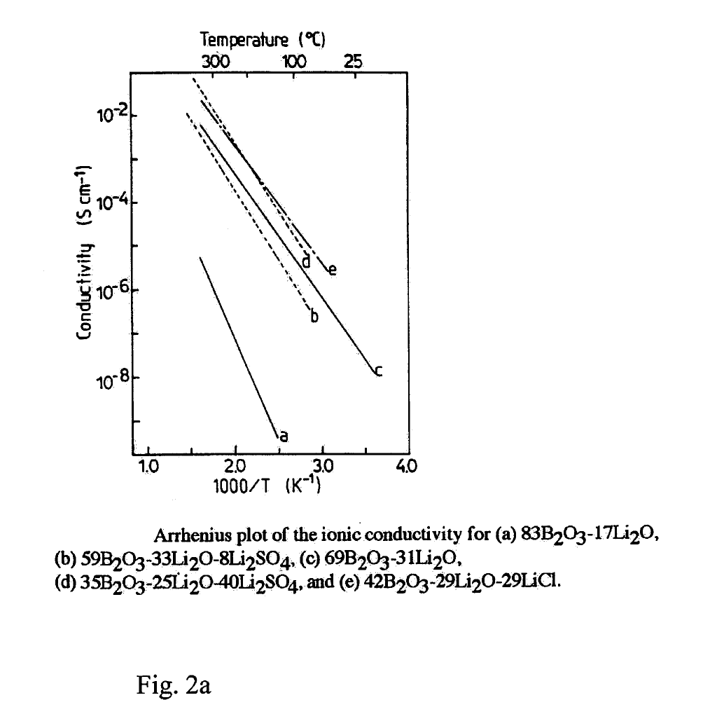

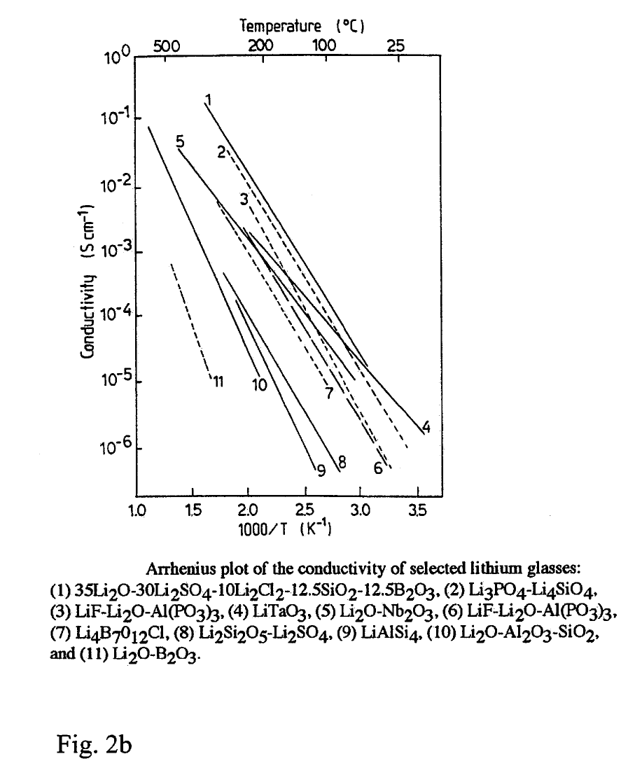

FIG. 1 shows the in-principle sequence of the three significant layers 1 to 3 for a single repeating unit of a composite cathode layer structure using single layers.

One particular aspect of the structure described and a feature of the invention is the procedures for producing the cathode layer 1 and the further layer 2 bonded by a material-to-material bond in each case on one side on opposite surfaces of the cathode layer 1 and the barrier layer 3. An objective of the procedures described is to make the composites of the layers 1, 2 and 3 as low as possible in stresses from thermomechanical points of view.

To produce the cathode layer 1, the pulverulent starting components (active constituents): active material, ion-conductive glass or an ion-conductive ceramic material which is sinterable at low temperatures and also an electrically conductive carbon phase are mixed in suitable proportions together with auxiliaries suitable for tape casting, for example organic binders and solvents and also further additives, to give a castable slip.

As regards the constituents, the following proportions are adhered to: active material 50% by volume-85% by volume (preferably 70-85% by volume) glass/ceramic capable of conducting lithium ions 10% by volume-35% by volume (preferably 10-20% by volume)

carbon phase 5% by volume-15% by volume (5 to 10% by volume).

Here, the proportions of organic binder and solvent are not taken into account.

As active material, it is possible to use, in particular, lithium-nickel-manganese-cobalt oxide (NMC) and lithium-cobalt oxide (LCO), and as glass it is possible to use, in particular, lithium-containing glasses which contain as glass formers B₂O₃, P₂O₅ or SO₃ and further glass-forming oxides (e.g. SiO₂, ZnO, GeO₂, TeO₂) which lead to a low-melting character of the glasses. A person skilled in the art will know that further potentially suitable glass compositions of further oxides (e.g. alkali metal and alkaline earth metal oxides) can be present in order to be able to adapt the glass structure to the respective use in terms of relevant properties such as ionic conductivity, softening behavior, expansion and devitrification behavior. Thus, many glasses can be suitable for achieving the object, and these cannot be listed individually here. As electrically conductive carbon phase, it is possible to use graphite.

As usable auxiliaries, a nonexhaustive selection of chemical compounds is listed below:

Binder: polyvinyl butyral, polyvinyl alcohol, polypropylene carbonate, polymethyl methacrylate, polyvinylidene fluoride, alginates, celluloses, epoxy resins, UV-curing binders

Solvent: water, ethanol, acetone, toluene, methyl ethyl ketone, butanol, isopropanol, ethyl acetate, N-methyl-2-pyrrolidone; azeotropic mixtures (ethanol/methyl ethyl ketone/toluene; methyl isobutyl ketone/methanol; isopropanol/ethyl acetate; butanol/toluene; MEK/toluene/cyclohexanone) dispersant: polyester, polyamine, fish oil plasticizer: benzyl butyl phthalate, polyethylene glycol, dibutyl phthalate, diisononyl phthalate, polyalkylene glycol, dioctyl phthalate

A prerequisite for the function of the composite cathode layer structure is electrically conductive percolation of the carbon phase and ion-conductive percolation of the ion-conductive phase in the sintered layer composite. The use of appropriate laws for calculating percolation networks may be found in the prior art.

The slip obtained is cast by means of a technologically established “doctor blade” process to give a sheet having a thickness in the range from 50 μm to 500 μm (after drying). Pieces having the dimensions suitable for the subsequent sintering process can be cut from this dried green sheet. The pieces are laid in a sandwich arrangement between two SiC-based (e.g. Hexoloys) or carbon-based plates (Setters), additionally loaded in a suitable manner with compressive forces and subjected to a sintering process.

The in-principle procedure can in the simplest case be applied to a continuous monolithic composite cathode layer structure. In particular cases, other configurations can be suitable in order to minimize thermomechanical stresses in the bond to the ionically conducting barrier layer and as a consequence of the lithium incorporation and release reactions.

In one embodiment, the cathode layer can have a gradated multilayer structure in respect of the proportions of solid electrolyte and active material. In order to minimize the above-described mechanical stresses at the interface between the ionically conductive further layer and the electronically conductive barrier layer, a suitable gradated structure can be configured as follows. Starting from the middle of a three-layer or multilayer cathode layer, a gradient with varying ratios of active material to material which conducts lithium ions (ion-conductive glass) is produced respectively in the direction of the normals to the areas. Starting from the middle of the cathode layer pointing in the direction of the further layer and the barrier layer, the proportion of active material should decrease and the proportion of material which conducts lithium ions should correspondingly increase. FEM simulation calculations have shown that due to incorporation and release reactions of lithium in the active material during the charging and discharging processes, a critical mechanical stress maximum occurs directly at the interfaces. A more uniform distribution of the mechanical stresses can be achieved and the stress maximum at the interfaces can be minimized by the gradated structure described.

The heat treatment necessary for sintering comprises the complete removal of the organic binder and of the solvent and the actual subsequent sintering to form a dense composite microstructure consisting of lithium ion-conducting material, carbon phase and active material. At least one change of atmosphere or of furnace may optionally be necessary for carrying out the sintering process in order to avoid burning away of the setters (sintering aids) or adhesion of the sintered material to the latter. The loading of the setters should be selected so that the lateral shrinkage of the piece of sheet is converted completely into a pure shrinkage of thickness and no crack formation occurs.

In a particular embodiment, the sintering process during the production of a composite cathode layer structure according to the invention can be carried out in a microwave oven. The structure necessary for sintering in the setter-green sheet-setter arrangement (where the setters consist of carbon or SiC) is particularly suitable for sintering by means of microwave radiation having a frequency in the range from 2 GHz to 3 GHz, in particular 2.4 GHz, since at least the setters consisting of SiC couple with the MW radiation even at room temperature and transfer the heat achievable directly in the SiC ceramic directly to the sheet(s) to be sintered for the cathode layer, the further layer and/or the barrier layer. In this way, a very homogeneous temperature distribution in the material being sintered can be achieved at heating rates of >10 K/min when the irradiation with microwaves is appropriately controlled. This homogeneous temperature distribution leads to a low-stress composite microstructure, which can be considered to be a prerequisite for production of a stable solid-state battery. Likewise, setters based on suitable carbon modifications should be able to be heated directly by means of microwave radiation.

In order to be able of produce the electronically conductive binding to an anode belonging to an adjacent cell of a solid-state battery, a further layer 3 having electronic conductivity and without ionic conductivity is required as barrier layer. For this purpose, it is possible to use a further layer 3 consisting of a glass-carbon composite. To produce this layer 3, it is possible, for example, to produce a sheet in a manner similar to that described for the cathode layer 1. As a difference from the cathode layer 1, a glass powder which does not conduct lithium ions and an electrically conductive carbon phase is necessary.

The following proportions by volume should be adhered to:
glass phase 80% by volume-95% by volume
carbon phase 5% by volume-20% by volume

The sheet additionally containing ceramic particles in order to match the coefficient of thermal expansion of the resulting glass layer to that of the cathode layer 1 is not ruled out. Depending on the proportion of ceramic particles, the proportion of glass phase in the formulation of the sheet is reduced.

In order to be able to produce the ionically conductive bond to an anode belonging to the same electrochemical cell, a further layer 2 which conducts lithium ions is necessary as barrier layer or solid electrolyte on the other surface of the cathode layer 1 formed on the layer 3 which is not electrically conductive. A further layer 2 consisting of a lithium ion-conductive glass which is also present in the cathode layer 1 can be used for this purpose. To produce this further layer 2, it is possible, for example, to produce a sheet in a manner similar to that described for the cathode layer 1. As a difference from the cathode layer 1, only the lithium ion-conductive glass as powder is necessary as solid. The proportion of glass phase in the sheet is ideally 100% without taking into account the organic constituents. This film additionally containing ceramic particles in addition to the glass in order to match the coefficient of thermal expansion of the resulting glass layer to that of the cathode layer 1 is not ruled out.

The thicknesses of the cathode layer 1 provided on its two sides with the further layer 2 and the barrier layer 3 should approximate the following ranges:
1 cathode layer 50 μm-200 μm
2 ion-conducting barrier layer 5 μm-30 μm
3 electronically conductive barrier layer 5 μm-30 μm

The further layer 2 and/or the barrier layer 3, in particular, can also be applied in the form of a paste to a substrate which is preferably still present as green sheet and after the heat treatment and the sintering resulting therefrom forms the cathode layer 1 and, after drying, likewise be subjected to the heat treatment. The application of a paste can be effected by various known methods, for example printing, doctor blade coating, spraying or pouring. A very constant layer thickness should be adhered to here.

Example 1 for the production of a composite cathode layer structure having two functionally different glass-based layers on opposite surfaces of a cathode layer

In this working example, the layers 1, 2 and 3 are functionally joined to one another by material-to-material bonding as shown in FIG. 1 in a joint sintering step. For this purpose, the sheets of the layers 1, 2 and 3 are laminated to one another, the organic components are then removed in a heat treatment and the remaining layers are subsequently joined to one another by material-to-material bonding, on one side ion-conducting and on the other side electronically conducting, in a sintering step. On both sides of the cathode layer 1, the low softening temperatures of the glass phases in each case lead to only a comparatively low sintering temperature being required and a low-mechanical-stress composite resulting. The sintering temperature necessary depends on the softening behavior of the glass phase used. The viscosity ranges required for sintering glass-containing sheets and thus suitable temperatures can be derived from the literature by a person skilled in the art.

Example 2 for the production of a composite cathode layer structure having an ion-conducting glass layer and an electronically conducting metal layer

In this working example the layers 1 and 2 are functionally joined to one another by material-to-material bonding in a joint sintering step. For this purpose, the sheets of the cathode layers 1 and the further layer 2 are laminated and joined to one another by material-to-material bonding, on one side ion-conducting, in a sintering step. The low softening temperatures of the glass phases present in the sheets lead to only a comparatively low sintering temperature being necessary and a low-mechanical-stress composite resulting. The necessary sintering temperature depends on the softening behavior of the glass phase used. The viscosity ranges required for sintering of glass-containing sheets can be derived from the literature by a person skilled in the art.

In the next step, an electronically conductive metallic barrier layer 3 is applied on the opposite side of the cathode layer 1. Possible methods are wet-chemical deposition, sputtering, vapor deposition and pressing. Suitable metals are ones which do not form alloys with lithium and are electrochemically stable. Examples of such metals are copper, nickel, titanium and stainless steel.

Example 3 for the production of a composite cathode layer structure having an ion-conducting glass layer consisting of a plurality of ion-conducting glass phases.

In this working example, a thin green glass layer sheet (10 μm) having the composition of the solid electrolyte material (high-temperature-melting glass, garnet) is cast. A further layer 2 forming the solid electrolyte in the form of a composite sheet consisting of the glass utilized for the cathode layer 1 (low-temperature-melting glass in an amount of 50% by volume and glass used for the solid electrolyte in an amount of 50% by volume) is subsequently cast onto this layer and dried. A slip having the composition of the cathode layer 1 is poured onto this layer composite and dried. A metallic foil (optionally a porous foil such as pressed foam, mesh or nonwoven) consisting of nickel is laminated to form the barrier layer 3 onto this multilayer structure on the side opposite the glass layer and all layers are then functionally joined to one another by material-to-material bonding in a joint sintering step.

Example 4 for the production of a gradated composite cathode layer structure having in each case ionically and electronically conductive bonding to the barrier layers

Based on working examples 1 to 3, this composite cathode layer structure has a multilayer structure. Here, three cathode sheets each having different ratios of active material present for the solid electrolyte are cast in thicknesses of in each case about 40 μm.

Sheet 1: 80% by volume of active material, 15% by volume of ion-conductive glass/ceramic and 5% by volume of carbon phase

Sheet 2: 65% by volume of active material, 30% by volume of ion-conductive glass/ceramic and 5% by volume of carbon phase

Sheet 3: 50% by volume of active material, 45% by volume of ion-conductive glass/ceramic and 5% by volume of carbon phase

To build up a gradated cathode layer 1, these sheets are laid on top of one another in the order sheet 3—sheet 2—sheet 1—sheet 2—sheet 3 and laminated. The further processing with incorporation of the barrier layers 2 and 3 is carried out in a manner analogous to working examples 1 to 3.

As active material, it is possible to use LiNiₓMn_{y}Co_{z}O₂ where x+y+z=1 (NMC), as glass it is possible to use an Li₂O—B₂O₃ glass with further additives and as carbon it is possible to use graphite.

1. A composite cathode layer structure for lithium-based solid-state batteries, wherein a barrier layer (3) which is composed of an electronically conducting material which does not conduct lithium ions is present on a surface of a cathode layer (1) comprising an active material suitable for the temporary storage of lithium ions, a material which conducts lithium ions and electrons, and a further layer (2) which forms a barrier layer or a solid electrolyte and is composed of a material which is electronically nonconductive and conductive for lithium ions is present on the opposite surface of the cathode layer (1) and these layers are joined to the respective surface of the cathode layer (1) by material-to-material bonding as a result of sintering.

2. The composite cathode layer structure as claimed in claim 1, characterized in that the cathode layer (1) comprises an active material suitable for the temporary storage of lithium ions, a material which conducts lithium ions and electrons and/or
the barrier layer (3) comprises a metal or a carbon-containing glass or ceramic material and/or
the further layer (2) comprises a lithium ion-conducting glass or ceramic material.

3. The composite cathode layer structure as claimed in claim 1, characterized in that a ceramic material is present to match the thermal expansion in the barrier layer (3) and the further layer (2).

4. The composite cathode layer structure as claimed in claim 1, characterized in that the cathode layer (1), the barrier layer (3) and/or the further layer (2) comprise a lithium oxide-based glass, in particular glasses of the type Li₂O—B₂O₃ or Li₂O—P₂O₅, with further additives.

5. The composite cathode layer structure as claimed in claim 1, characterized in that a layer which additionally forms a solid electrolyte has been joined to the surface of the further layer (2) by material-to-material bonding as a result of sintering to the further layer (2).

6. The composite cathode layer structure as claimed in claim 1, characterized in that the proportion of active material in each case decreases in the cathode layer (1) from the middle of the cathode layer (1) pointing in the direction of the barrier layer (3) and of the further layer (2).

7. A process for producing a composite cathode layer structure as claimed in claim 1, characterized in that at least one green sheet which comprises an organic binder and a solvent and pulverulent active material present therein, a pulverulent material which conducts lithium ions and a pulverulent electronically conducting material is provided or coated
on one surface with a sheet or paste which comprises a pulverulent material which conducts lithium ions and
on the opposite surface with a sheet or paste comprising an electronically conducting material, in particular a metal or carbon; whereupon,
in a heat treatment, the organic components are firstly driven off and sintering in which the cathode layer (1) is joined over its area by a material-to-material bond to the barrier layer (3) and the further layer (2) is subsequently carried out.

8. The process as claimed in claim 7, characterized in that the heat treatment is carried out using microwaves, preferably having a frequency in the range from 2 to 3 GHz and using sintering aids in the material of which carbon is present or which are composed of carbon.

9. The process as claimed in claim 7, characterized in that active material in a proportion of 50% by volume-85% by volume, lithium ion-conductive glass or ceramic material in a proportion of 10% by volume-35% by volume and an electronically conducting material, in particular carbon, in a proportion of 5% by volume-15% by volume are used for producing the sheet for the cathode layer (1),
the further layer (2) comprises the lithium ion-conducting material which is present in the cathode layer,
and the barrier layer (3) comprises glass or ceramic material in a proportion of 80% by volume-95% by volume and electronically conducting material, in particular carbon, in a proportion of 5% by volume-20% by volume or a metal, in particular a metal foam, mesh, gauze or nonwoven,
where the proportions present in each case are in each case without the proportions of organic binder and solvent.

10. The process as claimed in claim 7, characterized in that the cathode layer (1) comprises at least three individual sheets which have been laminated on top of one another and
the proportions of active material present in the sheets have been made smaller going out from the middle of the stack formed by the at least three sheets.
